(19) United States
(12) Patent Application Publication
(10) Pub. No.: US 2014/0250954 A1
(43) Pub. Date: Sep. 11, 2014

(54) SMART PADLOCK

(71) Applicant: James F. Buzhardt, Nashville, TN (US)

(72) Inventor: James F. Buzhardt, Nashville, TN (US)

(21) Appl. No.: 13/787,686

(22) Filed: Mar. 6, 2013

(51) Int. Cl. E05B 39/04; E05B 67/00

(52) U.S. Cl. CPC E05B 39/04; E05B 67/00
USPC 70/20

(57) ABSTRACT

A self-contained portable locking apparatus is disclosed which collects, stores, displays, and/or transmits information each time the apparatus is opened, closed, or even merely handled. This information may include but is not limited to time, date, and the number of times the apparatus is used or handled. The functions and performance of the locking apparatus may be manually or remotely controlled and manipulated. The disclosed apparatus may be also manually or remotely interrogated and the information gathered by the apparatus may be locally stored and/or be transmitted to a remote receiver such as a cell phone or a computing device.

### TECHNICAL FIELD

This application relates generally to security devices, and more specifically relates to a portable locking device capable of keeping track of locking activities.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of the disclosed padlock in an example environment.

FIG. 2 shows example components of an embodiment of the disclosed padlock.

### DETAILED DESCRIPTION

While the present disclosure is described with reference to several illustrative embodiments described herein, it should be clear that the present disclosure is not limited to such embodiments. Therefore, the description of the embodiments provided herein is only illustrative of the present disclosure and should not limit the scope of the disclosure as claimed. In addition, while the following description references particular types of locking apparatus, such as padlocks, it will be appreciated that the disclosure may be used with other portable locks.

Briefly described, a self-contained portable lock is disclosed, including a padlock, that is configured to acquire event data such as information about the number of times the padlock is opened, closed, or even touched, date of use, time of use, location of use, type of use, picture or video of surrounding area at or around the time of use, and the like. The disclosed padlock may also include, in some embodiments, a receiver to receive remotely transmitted signals, for example from a smartphone, to interrogate the padlock and/or to control some functions of the padlock such as starting, stopping and resetting of some components of the padlock. In some embodiments the padlock may have a transmitter to transmit some of the gathered information to a user's smartphone or computing device. In some embodiments transmission of data from the padlock to another apparatus, or control and interrogation of the padlock, may be through a wire connection. Some embodiments may further include manual provisions to operate various functions of the padlock, such as different controls, settings, uploading of information, and downloading of control commands. In various embodiments, the padlock may include one or more of a power supply, a sensor, an event counter, a clock, a GPS, a transmitter, a receiver, a memory, a processor, a display, and a manual control panel. In other embodiments, a padlock processor may perform some analysis on the collected information and communicate the collected and/or analyzed data to a storage device and/or to an external host computer for future analysis and use.

On many occasions, such as when leaving property in rental storage space or transporting property in a shipping container, one may be suspicious of or may want to prevent unauthorized visits to the storage space or container or at least may want to keep a history of the visits for future audits. At the present time, to obtain surveillance information, for example from a rental storage facility, the property owner must first show damages and then make a legal claim for recovery from storage facility. In many cases, such as in transportation of goods by a trailer truck, this information may not even exist. In those cases in which a person decides to set up her own surveillance equipment, at home, at a rental storage facility, or on a trailer truck, the equipments and the set-up will be relatively expensive in addition to the fact that she may also need permission from the storage management. Such needs arise in many situations in which data and information about the openings, closings, or even touching a lock is of interest.

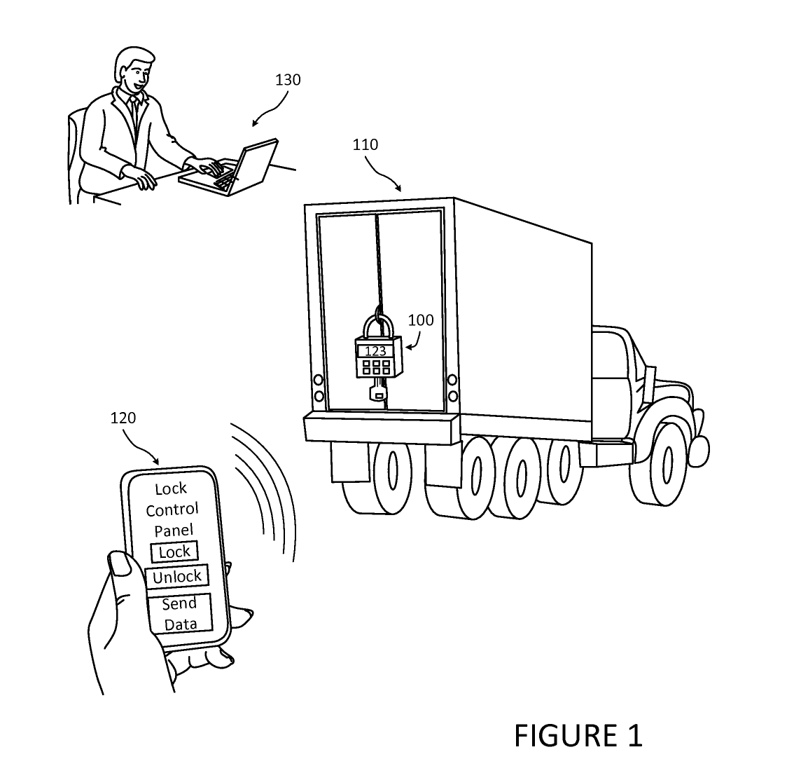

FIG. 1 shows an example padlock 100 used on a trailer truck 110, which is configured to at least record information about the time, date, place, and the number of times the padlock is opened or closed. In this example, padlock 100 is both controlled and monitored using a smartphone 120 or a laptop 130. In some embodiments padlock 100 may only be manually controlled, such as by mechanical manipulation or wired download of commands, or be controlled both manually and wirelessly. In the example of FIG. 1, a user can remotely acquire information about the date, the time, and the place of each opening of the padlock. The user can also remotely prevent the padlock 100 from opening or limit its ability to be opened to desired times, dates, and geographic places.

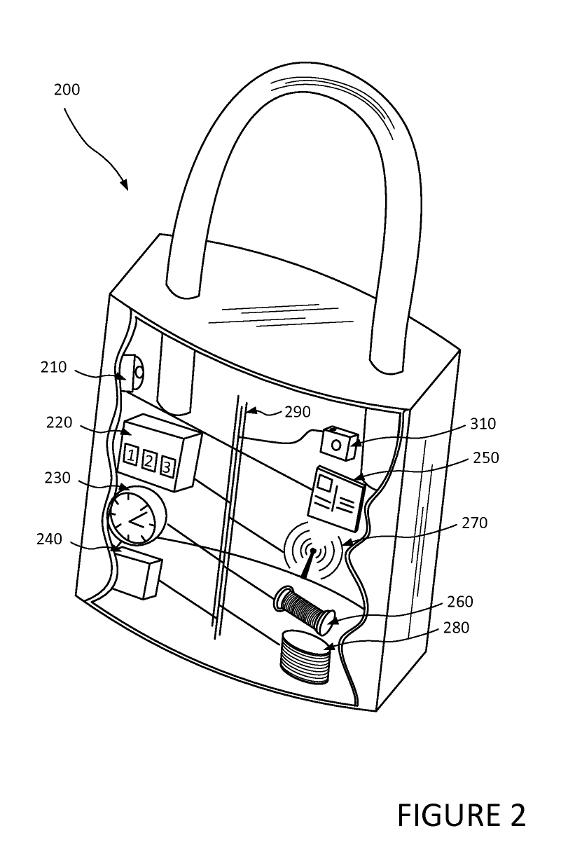

FIG. 2 shows components of an example padlock 200, which includes sensor 210, event counter 220, clock 230, GPS 240, processor 250, receiver 260, transmitter 270, data memory 280, and data bus 290. Sensor 210 can be an optical, magnetic, proximity, or a pressure sensor, or the like, for sensing an opening, a closing, or a mere touching of the padlock. For example sensor 210 may sense a movement of the shackle, bolt, cylinder, gear, or screw of the padlock 200. The example event counter 220 keeps track of the number of events sensed by sensor 210 or keeps count of the number of signals it receives from processor 250. In some embodiments event counter 220 can be manually or remotely reset. In yet other embodiments, output of the event counter 220 is stored in data memory 280, which may itself be a part of processor 250. In some embodiments data transfer and communication between the components of padlock 200 may be through data bus 290 and/or be managed by processor 250. In still other embodiments, event counter 220 may be implemented in software on processor 250 and its data maintained in non-volatile memory, such as flash memory.

Some embodiments, such as the one shown in FIG. 2, may include a clock 230, the output of which is used for time-stamping and dating an event such as an opening and/or closing of the padlock 200. In various embodiments the time and/or date of an opening may be recorded separately from the time and/or date of a closing event, or only the data about the time and/or date of opening event or closing event be collected. In other embodiments the time and/or date of an event may be remotely acquired. For example, each time an event happens, the transmitter 270 requests time and/or date from a remote location and receives the corresponding time and date by receiver 260. Such information and data may either be locally stored in data memory 280 and/or be wirelessly transmitted to a remote data storage device. Some embodiments of the padlock 200 may include a GPS 240 to gather information about the location of an event as well. In some embodiments, the location data may also be obtained remotely based on GPS coordinates

In some embodiments a wireless receiver 260 receives remotely-originated control and/or interrogation signals for setting or resetting the counter 220 or for interrogating the padlock for information and data. In these embodiments, a user can send a signal to a specific padlock 200 and request up-to-date information about events and/or, for example, reset the event counter 220 to zero. A user can also send a signal to start or stop collection of some event related information or to start collection of certain information at specific date and/or time. In various embodiments, the receiver 260 may receive control signals to override any manual control of the padlock 200 and to not allow, for example, manual opening of padlock 200 or manual setting of counter 220. In some other embodiments a wireless transmitter 270, such as an RF (Radio Frequency) or IR (Infra Red) transmitter, transmits at least a portion of the collected data and information to a remote receiver, such as to a computer 130 or to a smartphone 120. The transmission may be initiated automatically, for example at a specific time, periodically, or upon manual or remote interrogation of the padlock 200.

In various embodiments, the lock on padlock 200 may be controlled remotely to prevent local locking or unlocking of the padlock, while in other embodiments, the lock may be automatically disabled after a predetermined number of openings and closings to enforce an operational policy. Once the lock is automatically disabled, it can only be re-enabled by an external and/or remote command.

Various embodiments may include a display of some of the collected or analyzed data, such as display of the opening-closing count on an LED screen. The display may either be ON at all times or be manually or remotely turned on by the user, or be turned on each time the padlock 200 is touched or opened and/or closed, etc. The display may be so configured to allow scrolling through some or all available data.

In different embodiments the padlock 200 may be connected to a power supply, use a rechargeable battery, a non-rechargeable battery, or use solar energy or be able to charge up mechanically. In other embodiments the battery space or the recharging inlet of padlock 200 may be opened manually, by a remote control signal, or require both manual and remote control. In some embodiments the battery space or the recharging inlet of padlock 200 may have a separate key or combination lock.

In various embodiments, padlock 200 may be opened and/or closed by a key, a combination-lock, by RF signals, etc. In some embodiments some or all manual manipulations of padlock 200, such as extraction of event information, are only allowed after opening of the padlock 200.

In various embodiments padlock 200 may include a camera 310 which may be activated by touching and/or opening padlock 200. For example camera 310 may be set up to take a picture of a person opening padlock 200 or may be set up to take a video of its surrounding during the time between the opening and closing of padlock 200.

In some embodiments some of the event information may be obtained from outside of the padlock 200. In other embodiments padlock 200 may send request or command signals to outside devices. Such signals may be communicated by wire or wirelessly. For example an out-of-padlock camera may be wirelessly commanded by padlock 200 to take pictures anytime padlock 200 is manipulated. Similarly, in other embodiments padlock 200 may wirelessly set off an out-of-padlock alarm anytime an attempt is made to open padlock 200. In some embodiments even the kinds of manipulation, upon which padlock 200 performs a function, may be specified by the user. For example, the user may send a control signal directing padlock 200 to take a picture any time padlock 200 is even slightly touched by someone, or when it is being opened, and the like. In another example, any time sensor 210 senses an event, padlock 200 requests time and date from an out-of-padlock source.

In various embodiments all or some of padlock 200 components such as electronics, wiring, etc. are sealed, waterproof and shock proof. The disclosed padlock 200 may be used as a stand-alone security system—independent of sophisticated and expensive alarm systems—or be used in conjunction with existing alarm systems.

While controls, synchronizations, storage, etc., in example padlock 200 can be implemented using processor 250, same can be implemented without a processor. For example, upon detection of an event, such as opening of padlock 200, a signal generated by sensor 210 can trigger transmission of the event data from counter 220, clock 230, GPS 240, etc., to the user. Or, in various embodiments, receiver 260 can be hardwired to different padlock 200 components for controlling and resetting of those components each time a control signal is received by receiver 260.

Those skilled in the art will appreciate that the components and modules used in event data collection and processing functions may be packaged, integrated, or coupled together in many different ways without departing from the spirit of the present disclosures.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A powered self-contained portable locking device for locking an object and configured to collect data about operations performed on or by the locking device, wherein the locking device comprises:
a sensor for detecting an event of touching, handling, opening, closing or opening-and-closing of the locking device;
locking device facilities, including at least an event counter, a clock, or a GPS, for acquiring data related to an event; and
a memory unit for storing the data, wherein the detection of an event by the sensor causes at least a portion of the data to be stored in the memory unit.

2. The locking device of claim 1, further comprising a processor configured to communicate with the sensor, the memory unit, and the locking device facilities, wherein upon the receipt of a signal from the sensor signifying an event the processor arranges the storage of the acquired data into the memory unit.

3. The locking device of claim 1, further comprising a receiver configured to receive command signals for controlling functions and/or performance of the locking device and to receive interrogation signals about the data.

4. The locking device of claim 1, further comprising a transmitter configured to transmit the acquired data to a remote location and to transmit command and interrogation signals to sources out of the locking device.

5. The locking device of claim 1, further comprising a processor, a receiver, and a transmitter wherein the processor manages the receiver to receive wirelessly transmitted signals for controlling and interrogating the locking device and manages the transmitter to wirelessly transmit the acquired data to a remote location.

6. The locking device of claim 1, further comprising a display screen to display the acquired data.

7. The locking device of claim 1, further comprising manual inputs for setting/resetting and controlling the locking device facilities, functions, and performance.

8. The locking device of claim 1, further comprising a camera for taking a picture or a video of a person or an object outside the locking device.

9. The locking device of claim 1, wherein the locking device is a padlock.

10. The locking device of claim 1, wherein the locking device receives and transmits control and data signals using wired or wireless communication, or both.

11. A powered padlock for locking an object and configured to obtain information about actions performed on or by the padlock, the padlock comprising:
a sensor for sensing an event of touching, handling, opening, closing or opening-and-closing of the padlock; and
padlock components, including at least an event counter, a clock, or a GPS, for obtaining information related to an action performed on or by the padlock; and
a transmitter for transmitting the obtained information, wherein the sensing of an event by the sensor causes at least a portion of the information obtained by the padlock components to be transmitted to a desired location.

12. The padlock of claim 11, further comprising a processor configured to communicate with the sensor and the padlock components, wherein upon the receipt of a signal from the sensor signifying an event the processor arranges the transmission of the obtained information to a remote location.

13. The padlock of claim 11, further comprising a receiver configured to receive control and/or setting-resetting commands for controlling functions and/or performance of the padlock and to receive interrogation signals about the information.

14. The padlock of claim 11, wherein the transmitter also sends control and/or interrogation signals to sources and apparatus outside the padlock to obtain additional information and/or to start an action by the outside apparatus.

15. The padlock of claim 11, further comprising manual inputs for setting/resetting and controlling the padlock facilities, functions, and performance.

16. The padlock of claim 11, further comprising a camera for taking a picture or a video of a person or an object outside the padlock.

17. A powered self-contained padlock for locking an object and configured to collect data about operations performed on or by the padlock, the padlock comprising:
a sensor for detecting a mechanical movement of a padlock part; and
padlock accessories, including at least a movement counter, a clock, or a GPS, for acquiring data related to an operation performed on or by the padlock; and
a memory module for storing the data, wherein the detection of a mechanical movement of a padlock part causes at least a portion of the data to be stored in the memory module.

18. The padlock of claim 17, further comprising a processor configured to communicate with the sensor, the memory module, and the padlock accessories, wherein upon the receipt of a signal from the sensor signifying a mechanical movement the processor manages the storage of the acquired data into the memory module.

19. The padlock of claim 17, further comprising a receiver configured to receive control and/or setting-resetting commands for controlling functions and/or performance of the padlock or further includes manual inputs for setting-resetting and controlling the locking device facilities, functions, and performance, or includes both a receiver and manual inputs.

20. The padlock of claim 17, further comprising a transmitter configured to transmit command, interrogation, and the acquired data to a remote location.
